(19) United States
(12) Patent Application Publication
(10) Pub. No.: US 2024/0100631 A1
(43) Pub. Date: Mar. 28, 2024

(54) COMPOSITE COMPONENT, LASER PROCESSING METHOD, AND METHOD FOR MANUFACTURING COMPOSITE COMPONENT

(71) Applicant: Gigaphoton Inc., Tochigi (JP)

(72) Inventor: Yasufumi KAWASUJI, Oyama-shi (JP)

(73) Assignee: Gigaphoton Inc., Tochigi (JP)

(21) Appl. No.: 18/533,239

(22) Filed: Dec. 8, 2023

Related U.S. Application Data
(63) Continuation of application No. PCT/JP2021/026342, filed on Jul. 13, 2021.

(51) Int. Cl. B23K 26/402; B23K 26/382

(52) U.S. Cl. CPC B23K 26/402; B23K 26/389; B23K 2101/001

(57) ABSTRACT

A composite component includes a plurality of first fibers extending in a first direction, a plurality of second fibers extending in a second direction different from the first direction, and a matrix material with which gaps between the first fibers and the second fibers are filled, in which a plurality of holes are provided in each of at least one first row along the first direction and at least one second row along the second direction.

### CROSS-REFERENCE TO RELATED APPLICATIONS

The present application is a continuation application of International Application No. PCT/JP2021/026342, filed on Jul. 13, 2021, the entire contents of which are hereby incorporated by reference.

### BACKGROUND

### 1. Technical Field

The present disclosure relates to a composite component, a laser processing method, and a method for manufacturing a composite component.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as the gas laser apparatus for exposure, a KrF excimer laser apparatus that outputs a laser beam having a wavelength of about 248.0 nm and an ArF excimer laser apparatus that outputs a laser beam having a wavelength of about 193.4 nm are used.

Spectral linewidths of natural oscillation beams of the KrF excimer laser apparatus and the ArF excimer laser apparatus are as wide as between 350 pm and 400 pm. Therefore, when a projection lens is formed of a material that transmits ultraviolet rays such as KrF laser beam and ArF laser beam, there may be a case in which chromatic aberration occurs. As a result, the resolution may decrease. Then, a spectral linewidth of laser beam output from the gas laser apparatus needs to be narrowed to the extent that the chromatic aberration is ignorable. Therefore, in the laser resonator of the gas laser apparatus, in order to narrow the spectral linewidth, a line narrowing module (LNM) including a line narrowing element (etalon, grating, etc.) may be provided. Hereinafter, a gas laser apparatus with a narrowed spectral linewidth is referred to as a line narrowing gas laser apparatus.

### LIST OF DOCUMENT

### Patent Document

Patent Document 1: Japanese Unexamined Patent Application Publication No. 2013-202689

### SUMMARY

A composite component according to an aspect of the present disclosure may include a plurality of first fibers extending in a first direction, a plurality of second fibers extending in a second direction different from the first direction, and a matrix material with which gaps between the first fibers and the second fibers are filled, and a plurality of holes may be provided in each of at least one first row along the first direction and at least one second row along the second direction.

A laser processing method according to an aspect of the present disclosure may include irradiating a workpiece with a laser beam, the workpiece including a plurality of first fibers extending in a first direction, a plurality of second fibers extending in a second direction different from the first direction, and a matrix material with which gaps between the first fibers and the second fibers are filled, to provide a plurality of holes in each of at least one first row along the first direction and at least one second row along the second direction.

A method for manufacturing a composite component according to an aspect of the present invention is a method for manufacturing a composite component by laser processing on a workpiece, the workpiece including a plurality of first fibers extending in a first direction, a plurality of second fibers extending in a second direction different from the first direction, and a matrix material with which gaps between the first fibers and the second fibers are filled, the method including laser processing the workpiece to provide a plurality of holes in each of at least one first row along the first direction and at least one second row along the second direction.

### BRIEF DESCRIPTION OF THE DRAWINGS

Embodiments of the present disclosure will be described below merely as examples with reference to the accompanying drawings.

FIG. 1 is a front view of a composite component of a comparative example.

FIG. 2 is a schematic diagram illustrating an overall schematic configuration example of the processing system of the comparative example.

FIG. 3 is a flowchart illustrating an example of a flowchart of a method for manufacturing a composite component of the comparative example.

FIG. 4 is a diagram illustrating an example of a control flowchart of the laser processing method of the comparative example.

FIG. 5 is a front view of a composite component of the first embodiment.

FIG. 6 is a perspective view of the composite component of the second embodiment.

FIG. 7 is a side view of a table according to the second embodiment.

### DESCRIPTION OF EMBODIMENTS

1. Overview
2. Description of composite component, laser processing method, and method for manufacturing composite component of comparative example
   2.1 Composition of composite component of comparative example
   2.2 Configuration of laser processing system for manufacturing composite component of comparative example
   2.3 Operation
   2.4 Problem
3. Description of composite component, laser processing method, and method for manufacturing composite component according to first embodiment
   3.1 Configuration of composite component of first embodiment
   3.2 Configuration of laser processing system for manufacturing composite component of first embodiment
   3.3 Operation
   3.4 Function and effect method, and method for manufacturing composite component of second embodiment
   4.1 Configuration of composite component of second embodiment
   4.2 Configuration of laser processing system for manufacturing composite component of second embodiment
   4.3 Operation
   4.4 Function and effect

Hereinafter, embodiments of the present disclosure will be described in detail with reference to the drawings.

The embodiments described below show some examples of the present disclosure and do not limit the content of the present disclosure. Also, all configurations and operations described in the embodiments are not necessarily essential as configurations and operations of the present disclosure. The same constitutive elements are denoted by the same reference numerals, and duplicate description thereof is omitted.

### 1. Overview

Embodiments of the present disclosure relate to a composite component provided with a plurality of holes formed by removing parts of a workpiece by laser processing, a laser processing method, and a method for manufacturing the composite component.

### 2. Description of Composite Component, Laser Processing Method, and Method for Manufacturing Composite Component of Comparative Example

### 2.1 Composition of Composite Component of Comparative Example

A composite component of the comparative example is described hereinafter. The comparative example of the present disclosure is an example recognized by the applicant as known only by the applicant, and is not a publicly known example admitted by the applicant.

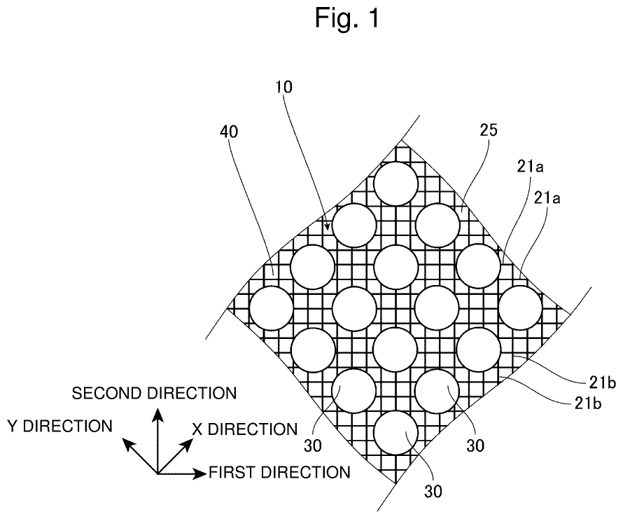

FIG. 1 is a front view of a composite component of a comparative example. In FIG. 1, a part of the front face of a composite component 10 is illustrated. Further, in FIG. 1, for the sake of clarity, reference numerals are given only to a part of the same constitutive elements, and some reference numerals are omitted.

The composite component 10 is, for example, plate-shaped. The composite component 10 comprises a plurality of first fibers 21a, a plurality of second fibers 21b, and a matrix material 25. The composite component 10 may be, for example, a ceramic matrix composite (CMC). In this case, the first fibers 21a and the second fibers 21b respectively include, for example, any of a silicon carbide fiber, a carbon fiber, a silicon nitride fiber, an alumina fiber, and a boron nitride fiber. The first fibers 21a and the second fibers 21b may respectively be fibers made of other suitable ceramics. Examples of the matrix material 25 include silicon carbide.

Fiber bundles of the first fibers 21a and the second fibers 21b are arranged in a first direction and a second direction along the main surface of the composite component 10. Specifically, the first fibers 21a extend in the first direction, and the second fibers 21b extend in the second direction different from the first direction. The first direction is generally orthogonal to the second direction.

The first fibers 21a and the second fibers 21b are arranged in a square grid. That is, the first fibers 21a adjacent to each other are arranged in parallel, and the second fibers 21b adjacent to each other are arranged in parallel. Note that the first fibers 21a adjacent to each other may be arranged substantially parallel to each other. In this case, the first fibers 21a adjacent to each other may be arranged within ±10° from parallel, preferably within ±3° from parallel. Also, the second fibers 21b adjacent to each other may be arranged substantially parallel to each other in the same manner as the first fibers 21a.

The first fibers 21a are woven into the second fibers 21b. The weaving includes, for example, plain weaving, in which fiber bundles consisting of the first fibers 21a and the second fibers 21b are woven crosswise from two directions: the first direction and the second direction. The fiber bundles are impregnated with the matrix material 25, and gaps between the first fibers 21a and the second fibers 21b are filled with the matrix material 25.

A plurality of holes 30 are provided in the composite component 10 in which the first fiber 21a and the second fiber 21b are woven together as described above. Each hole 30 is provided at an irradiation position of the laser beam on the workpiece 40. The workpiece 40 is an object to which laser processing is performed by irradiation with laser beam, and is a member in which the holes 30 are not provided. On the other hand, the composite component 10 is the workpiece 40 provided with the holes 30. In the composite component 10 of the present example, the holes 30 are assumed to be through holes. In the area of the composite component 10 where the holes 30 are provided, the first fibers 21a and the second fibers 21b are cut and removed, and the matrix material 25 is removed.

In FIG. 1, an example is shown in which the cross-sectional shapes of the respective holes 30 are circular, and the respective cross-sections have the same diameter. The diameter is greater than a thickness of each of the first fiber 21a and the second fiber 21b, a distance between adjacent first fibers 21a, and a distance between adjacent second fibers 21b. The cross-sectional shape and the diameter of each hole 30 are not particularly limited.

When the composite component 10 is viewed from the front, the respective centers of the holes 30 are provided at respective corners of the square, and therefore, the holes 30 are arranged in a square grid similarly to the first fibers 21a and the second fibers 21b. However, the direction of the arrangement of the holes 30 is not the same as the direction of the arrangement of the first fibers 21a and the second fibers 21b, but is inclined, for example approximately 45° counterclockwise, with respect to the direction of the arrangement of the first fibers 21a and the second fibers 21b. Specifically, with regard to the arrangement of the holes 30, the holes 30 are provided in each of the first rows along the X-direction and each of the second rows along the Y-direction orthogonal to the X-direction. The X direction is inclined approximately 45° counterclockwise with respect to the first direction, and the Y direction is inclined approximately 45° counterclockwise with respect to the second direction.

Since the holes 30 are arranged in a square grid as described above, lines adjacent to each other among lines passing through the centers of the holes 30 provided in the first rows are arranged in parallel. Note that one of the lines adjacent to each other may be arranged substantially parallel to the other line. In this case, the lines adjacent to each other may be arranged within ±10° from parallel, preferably within ±3° from parallel. Also, among lines passing through the centers of the holes 30 provided in the second rows, adjacent lines are arranged in parallel. Note that one of the lines adjacent to each other may be arranged substantially parallel to the other line, similarly to the lines adjacent to each other in the first rows described above.

### 2.2 Configuration of Laser Processing System for Manufacturing Composite Component of Comparative Example

Next, a laser processing system 50 for manufacturing the composite component 10 of the comparative example will be described.

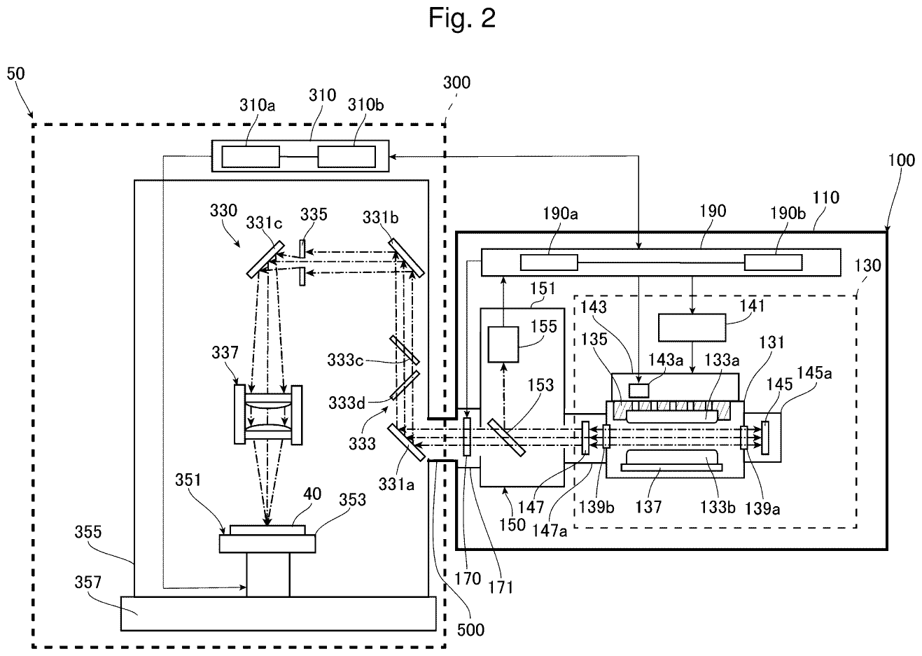

FIG. 2 is a schematic diagram illustrating an overall schematic configuration example of the laser processing system of the comparative example. The laser processing system 50 mainly includes a gas laser apparatus 100, a laser processing apparatus 300, and an optical path pipe 500 that connects the gas laser apparatus 100 to the laser processing apparatus 300.

The gas laser apparatus 100 is an ArF excimer laser apparatus using a mixed gas containing, for example, argon (Ar), fluorine (F₂), and neon (Ne). The gas laser apparatus 100 outputs a laser beam having a center wavelength of about 193.4 nm. Note that the gas laser apparatus 100 may be a gas laser apparatus other than the ArF excimer laser apparatus, and may be, for example, a KrF excimer laser apparatus using a mixed gas containing krypton (Kr), F₂, and Ne. The gas laser apparatus 100 outputs a laser beam having a center wavelength of about 248.0 nm. A mixed gas containing Ar, F₂, and Ne which is a laser medium, or a mixed gas containing Kr, F₂, and Ne, which is a laser medium, may be referred to as a laser gas. In the mixed gas used in each of the ArF excimer laser apparatus and the KrF excimer laser apparatus, helium (He) may be used instead of Ne.

The gas laser apparatus 100 mainly includes a housing 110, a laser oscillator 130 disposed in an internal space of the housing 110, a monitor module 150, a shutter 170, and a laser processor 190.

The laser oscillator 130 includes a laser chamber 131, a charger 141, a pulse power module 143, a rear mirror 145, and an output coupling mirror 147. FIG. 2 shows an internal configuration of the laser chamber 131 when viewed from a direction substantially perpendicular to the traveling direction of the laser beam.

The laser chamber 131 includes an internal space in which light is generated by excitation of the laser medium in the laser gas. The laser gas is supplied from a laser gas supply source (not shown) to an internal space of the laser chamber 131 via a pipe (not shown). The light generated by excitation of the laser medium travels to windows 139a and 139b which will be described later.

In the inner space of the laser chamber 131, a pair of electrodes 133a and 133b are disposed such that they face each other. The longitudinal direction of the electrodes 133a and 133b is along the traveling direction of the light generated by the high voltage applied between the electrode 133a and the electrode 133b. The electrodes 133a and 133b are discharge electrodes for exciting the laser medium by glow discharge. In this embodiment, the electrode 133a is the cathode and the electrode 133b is the anode.

The electrode 133a is supported by an electrically insulating portion 135. The electrically insulating portion 135 closes an opening formed in the laser chamber 131. A conductive portion is embedded in the electrically insulating portion 135, and the conductive portion applies a high voltage supplied from the pulse power module 143 to the electrode 133a. The electrode 133b is supported by the return plate 137. The return plate 137 is connected to the inner surface of the laser chamber 131 by wiring (not shown).

The charger 141 is a DC power supply device that charges a charging capacitor (not shown) in the pulse power module 143 with a predetermined voltage. The pulse power module 143 includes a switch 143a controlled by the laser processor 190. When the switch 143a is switched from OFF to ON, the pulse power module 143 generates a pulsed high voltage from the electric energy held in the charger 141 and applies this high voltage between the electrode 133a and the electrode 133b.

When a high voltage is applied between the electrode 133a and the electrode 133b, discharging occurs between the electrode 133a and the electrode 133b. The energy of the discharge excites the laser medium in the laser chamber 131. Light is output when the excited laser medium transitions to the ground state.

The laser chamber 131 is provided with the windows 139a and 139b. The window 139a is located at one end side in the traveling direction of the laser beam in the laser chamber 131, and the window 139b is located at the other end side in the traveling direction of the laser beam in the laser chamber 131. The windows 139a and 139b sandwich a space between the electrode 133a and the electrode 133b. The laser beam oscillated as described later is output to the outside of the laser chamber 131 through the windows 139a and 139b. As described above, since the pulsed high voltage is applied between the electrode 133a and the electrode 133b by the pulse power module 143, the laser beam is a pulsed laser beam.

The rear mirror 145 is disposed in an internal space of the housing 145a connected to one end of the laser chamber 131, and reflects the laser beam output from the window 139a and returns the laser beam to the internal space of the laser chamber 131. The output coupling mirror 147 is disposed in an internal space of an optical path pipe 147a connected to the other end of the laser chamber 131, transmits a part of the laser beam output from the window 139b, and reflects the other part back to the internal space of the laser chamber 131. Thus, the rear mirror 145 and the output coupling mirror 147 constitute a Fabry-Perot laser resonator, and the laser chamber 131 is disposed in the optical path of the laser resonator.

The monitor module 150 is disposed in the optical path of the laser beam output from the output coupling mirror 147. The monitor module 150 includes a housing 151, a beam splitter 153 and an optical sensor 155 disposed in an internal space of the housing 151. An opening is formed in the housing 151, and the internal space of the housing 151 communicates with the internal space of the optical path pipe 147a through the opening.

The beam splitter 153 transmits the laser beam output from the output coupling mirror 147 toward the shutter 170 with a high transmittance, and reflects a part of the laser beam toward the light receiving surface of the optical sensor 155. The optical sensor 155 measures the energy E of the laser beam incident on the light receiving surface. The optical sensor 155 is electrically connected to the laser processor 190 and outputs a signal indicative of the measured energy E to the laser processor 190.

The disclosed laser processor 190 is a processor that includes a storage device 190a in which a control program is stored and a CPU (central processing unit) 190b that executes the control program. The laser processor 190 is specifically configured or programmed to execute various processes included in the present disclosure. The laser processor 190 controls the entire gas laser apparatus 100. The laser processor 190 transmits and receives various signals to and from the laser processing processor 310 of the laser processing apparatus 300.

The shutter 170 is disposed in the optical path of the laser beam transmitted through the beam splitter 153 in the internal space of an optical path pipe 171 connected to the housing 151 of the monitor module 150. The optical path pipe 171 is connected to a side of the housing 151 opposite to a side to which the optical path pipe 147a is connected, and an internal space of the optical path pipe 171 communicates with an internal space of the housing 151 via the opening formed in the housing 151. Further, the optical path pipe 171 communicates with the optical path pipe 500 via an opening formed in the housing 110.

The shutter 170 is electrically connected to the laser processor 190. The laser processor 190 closes the shutter 170 until the difference ΔE between the energy E received from the monitor module 150 and the target energy Et received from the laser processing processor 310 falls within an allowable range. The laser processor 190 also opens the shutter 170 upon receiving a signal indicative of a light output trigger Tr from the laser processing processor 310. When the shutter 170 is open, the laser beam from the beam splitter 153 passes through the shutter 170 and the optical path pipe 500 and travels to the laser processing apparatus 300. The light output trigger Tr is defined by a predetermined repetition frequency f of the laser beam and a predetermined pulse number P, and is a timing signal with which the laser processing processor 310 causes the laser oscillator 130 to generate laser oscillation, and is an external trigger. The repetition frequency f of the laser beam is, for example, greater than or equal to 1 kHz and less than or equal to 10 kHz.

The internal spaces of the optical path pipe 171 and the optical path pipe 147a and the internal spaces of the housing 151 and the housing 145a are filled with purge gas. The purge gas contains an inert gas such as high purity nitrogen. The purge gas is supplied from a purge gas supply source (not shown) to the internal space through a pipe (not shown).

The laser processing apparatus 300 mainly includes the laser processing processor 310, an optical system 330, a stage 351, a housing 355, and a frame 357. The optical system 330 and the stage 351 are disposed in an internal space of the housing 355. The housing 355 is fixed to the frame 357. The optical path pipe 500 is connected to the housing 355, and the internal space of the housing 355 communicates with an internal space of the optical path pipe 500 via an opening formed in the housing 355.

The laser processing processor 310 is a processor that includes a storage device 310a in which a control program is stored and a CPU 310b that executes the control program. The laser processing processor 310 is specifically configured or programmed to execute various processes included in the present disclosure. The laser processing processor 310 controls the entire laser processing apparatus 300. The storage device 310a stores parameters including the pulse number of the laser beam required for providing one hole 30, the order of processing of the respective holes 30 to be provided in the workpiece 40, and the position data of the respective holes 30. The pulse number is set in advance based on the material of the workpiece 40, the shape of the holes 30, the depth of the holes 30, and the intensity of the laser beam.

The optical system 330 includes highly reflective mirrors 331a, 331b, and 331c, an attenuator 333, a mask 335, and a transfer optical system 337. As for the components of the optical system 330, each component is fixed to a holder (not shown) and is disposed at a predetermined position in the housing 355.

The highly reflective mirrors 331a, 331b, and 331c reflect the laser beam with a high reflectance. The highly reflective mirror 331a reflects the laser beam entering from the gas laser apparatus 100 toward the attenuator 333. The highly reflective mirror 331b reflects the laser beam from the attenuator 333 toward the highly reflective mirror 331c. The highly reflective mirror 331c reflects the laser beam toward the transfer optical system 337.

The attenuator 333 is disposed in an optical path between the highly reflective mirror 331a and the highly reflective mirror 331b. The attenuator 333 includes partially reflective mirrors 333c and 333d. The partially reflective mirrors 333c and 333d are individually fixed to rotating stages (not shown). Each rotating stage is electrically connected to the laser processing processor 310 and rotates about an axis by a control signal of the laser processing processor 310. The respective axes of the rotating stages are perpendicular to a fixed surface of the rotating stages to which the partially reflective mirrors 333c and 333d are fixed. The rotation of the respective rotating stages also causes the partially reflective mirrors 333c and 333d to rotate. The partially reflective mirrors 333c and 333d are optical devices in which the transmittance of the partially reflective mirrors 333c and 333d varies depending on the incident angle of the laser beam to the partially reflective mirrors 333c and 333d. The rotation angle of the partially reflective mirrors 333c and 333d is adjusted by the rotation of the respective rotating stages so that the incident angles of the laser beams coincide with each other and the transmittance of the partially reflective mirrors 333c and 333d becomes the desired transmittance. As a result, the laser beam from the highly reflective mirror 331a is attenuated to a desired energy level and passes through the attenuator 333.

The mask 335 is disposed between the highly reflective mirror 331b and the highly reflective mirror 331c. The mask 335 is, for example, a plate-shaped member provided with a circular transmission hole through which a part of the laser beam is transmitted and blocking another part of the laser beam. The shape of the transmission hole is not limited. The mask 335 includes a changeable mechanism (not shown) capable of changing the size of the transmission hole, and the size of the transmission hole can be adjusted according to the size of the hole 30 formed in the workpiece 40. As the laser beam passes through the transmission hole, a transfer pattern corresponding to the hole 30 is formed. When the transfer pattern is transferred to the workpiece 40, the hole 30 corresponding to the shape of the transmission hole is formed in the workpiece 40.

The transfer optical system 337 focuses the laser beam on the workpiece 40 so that the transfer pattern forms an image at an imaging position located at a predetermined depth from the surface side of the workpiece 40. The transfer optical system 337 is composed of a combination of a plurality of lenses. The transfer optical system 337 is a reduction optical system that forms an image of a circular transfer pattern having a size smaller than the size of the transmission hole of the mask 335 at an imaging position. The magnification of the transfer optical system 337 is, for example, 1/10 to ⅕. Although the transfer optical system 337 has been exemplified by a combination of lenses, in a case where one small circular transfer pattern is formed in the vicinity of the optical axis of the transfer optical system 337, the transfer optical system 337 may be composed of a single lens.

The stage 351 includes a table 353. The table 353 supports the workpiece 40. The main surface of the table 353 is substantially orthogonal to the optical axis of the laser beam with which the workpiece 40 is irradiated. The stage 351 is disposed on the bottom surface of the housing 355, and is capable of moving the table 353 in the width direction, the length direction, and the thickness direction of the table 353 by a control signal from the laser processing processor 310, and adjusts the position of the table 353 by the movement. Accordingly, the stage 351 moves the workpiece 40 through the table 353 so that the workpiece 40 is irradiated with the laser beam output from the optical system 330, and adjusts the position of the workpiece 40.

During operation of the laser processing system 50, an inert gas constantly flows in the internal space of the housing 355. The inert gases are, for example, nitrogen (N₂). The housing 355 is provided with an inlet port (not shown) for suctioning the inert gas into the housing 355, and an outlet port (not shown) for discharging the inert gas from the housing 355 to the outside. An inlet pipe and an outlet pipe (not shown) are connected to the inlet port and the outlet port. An inert gas supply source (not shown) for supplying an inert gas is connected to the inlet port. The inert gas supplied from the inlet port also flows to the optical path pipe 500 communicating with the housing 355. The housing 355 suppresses contamination of the internal space of the housing 355, in which the workpiece 40 is disposed, by impurities.

### 2.3 Operation

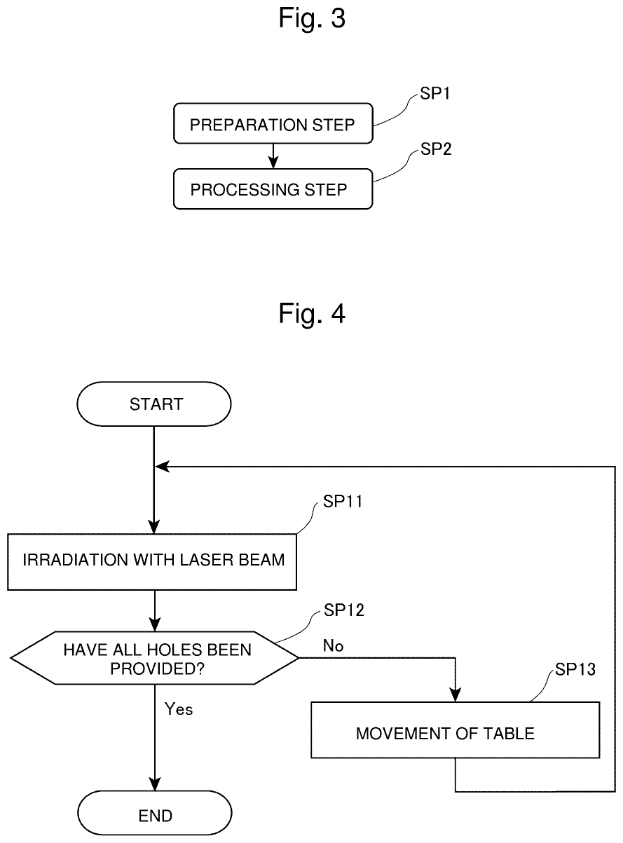

FIG. 3 is a diagram illustrating an example of a flowchart of a method for manufacturing the composite component 10 of the comparative example. The method for manufacturing the composite component 10 mainly includes a preparation step SP1 and a processing step SP2. In the preparation step SP1, the workpiece 40 is supported by the table 353 of the stage 351. In the processing step SP2, the workpiece 40 is subjected to laser processing, and the composite component 10 is manufactured by laser processing.

Next, the operation of the laser processing system 50 in the processing step SP2 of the comparative example will be described. FIG. 4 is a diagram illustrating an example of a control flowchart of the laser processing method of the processing step SP2 of the comparative example. The laser processing method includes step SP11, step SP12, and step SP13.

First, the initial state shown in FIG. 4 will be described. The initial state is a state prior to the gas laser apparatus 100 outputting the laser beam, and in this state, the internal spaces of the optical path pipes 147a, 171, and 500 and the internal spaces of the housings 145a and 151, are filled with purge gas from a purge gas supply source (not shown). A laser gas is supplied to the internal space of the laser chamber 131 from a laser gas supply source (not shown). In the laser processing apparatus 300, an inert gas flows in the internal space of the housing 355.

Further, in the initial state, in the laser processing apparatus 300, the laser processing processor 310 reads the parameter stored in the storage device 310a. When the parameter is read, the laser processing processor 310 moves the table 353 via the stage 351 so that the laser beam is applied to the position where the hole 30 is to be provided on the basis of the position data of the hole 30 to be processed first. The irradiation position is an imaging position at which the above-described transfer pattern is imaged. As a result, the table 353 moves to the set initial irradiation position. After the table 353 moves, the control flow proceeds to step SP11. Note that the operation in the above-described initial state may be performed in the preparation step SP1.

### (Step SP11)

In this step, first, the laser processing processor 310 controls the gas laser apparatus 100 so that the laser beam with which the workpiece 40 is irradiated has a desired fluence Fm required for the laser processing. Under the control of the gas laser apparatus 100, the laser processing processor 310 reads the target energy Et stored in the laser processing processor 310. The target energy Et is a target value of energy required for the laser processing. Next, the laser processing processor 310 transmits a signal indicating the read target energy Et to the laser processor 190 of the gas laser apparatus 100. Upon receiving the signal indicating the target energy Et, the laser processor 190 sets the target energy Et as an energy Em required during the laser processing. The target energy Et may be stored in the storage device 190a of the laser processor 190.

The fluence Fm is the energy-density of the laser beam on the surface of the workpiece 40 irradiated with the laser beam. In the optical system 330, the loss of the laser beam shielded by the mask 335 is great, and in order to obtain a desired fluence Fm, the energy Em is defined in consideration of this optical loss.

The laser processor 190 closes the shutter 170 and activates the charger 141 so that the energy of the laser beam matches the energy Em. In addition, the laser processor 190 turns on the switch 143a of the pulse power module 143 by an internal trigger (not shown). As a result, the pulse power module 143 applies a pulsed high voltage between the electrode 133a and the electrode 133b from the electric energy retained by the charger 141. This high voltage causes discharging between the electrode 133a and the electrode 133b, and the laser medium contained in the laser gas between the electrode 133a and the electrode 133b is brought into an excited state, and outputs light when the laser medium returns to the ground state. The output light resonates between the rear mirror 145 and the output coupling mirror 147, and is amplified every time it passes through the discharge space in the internal space of the laser chamber 131, so that laser oscillation occurs. A part of the laser beam passes through the output coupling mirror 147 and travels to the beam splitter 153.

The part of the laser beam having traveled to the beam splitter 153 is reflected by the beam splitter 153 and received by the optical sensor 155. The optical sensor 155 measures the energy E of the received laser beam. The optical sensor 155 outputs a signal indicating the measured energy E to the laser processor 190. The laser processor 190 feedback-controls the charge voltage of the charger 141 so that the difference ΔE between the energy E and the target energy Et falls within the allowable range. After the difference ΔE has been within the allowable range, the laser processor 190 transmits, to the laser processing processor 310, a reception preparation completion signal indicating that the reception preparation of the light output trigger Tr of the laser beam is completed.

Upon reception of the reception preparation completion signal, the laser processing processor 310 controls the transmittance Tm of the attenuator 333 so that the laser beam with which the workpiece 40 is irradiated has the fluence Fm required for laser processing.

As described above, when the energy E and the transmittance Tm are controlled, the laser processing processor 310 transmits the light output trigger Tr to the laser processor 190. Consequently, in synchronization with the reception of the light output trigger Tr, the laser processor 190 opens the shutter 170, and the laser beam that has passed through the shutter 170 enters the laser processing apparatus 300. The laser beam is, for example, a pulsed laser beam having a center wavelength of 193.4 nm.

The laser beam having entered the laser processing apparatus 300 travels to the transfer optical system 337 via the highly reflective mirror 331a, the attenuator 333, the highly reflective mirror 331b, the mask 335, and the highly reflective mirror 331c. The transfer pattern is imaged at the above-described imaging position by the laser beam transmitted through the transfer optical system 337.

The workpiece 40 is irradiated with the laser beam in accordance with a light output trigger Tr defined by the repetition frequency f and the pulse number P required for the laser processing. When the irradiation with the laser beam is continued, ablation occurs in the vicinity of the surface of the workpiece 40, and defects are generated. Thus, the hole 30 is provided in the workpiece 40. As described above, this step is an irradiation step in which the hole 30 is provided through irradiation of the workpiece 40 with the laser beam.

In this step, the laser processing processor 310 drives the gas laser apparatus 100 to output the laser beam from the gas laser apparatus 100 toward the workpiece 40 supported by the table 353 with the pulse number read from the parameters. By the irradiation, one hole 30 is provided at the irradiation position in the workpiece 40. When one hole 30 is provided, the laser processing processor 310 closes the shutter 170 via the laser processor 190, and stops the progress of the laser beam to the laser processing apparatus 300. When the progress of the laser beam is stopped, the laser processing processor 310 advances the control flow to step SP12.

### (Step SP12)

In this step, the laser processing processor 310 reads the position data of the hole 30 of the processing order subsequent to that of the hole 30 provided in step SP11 from the parameter stored in the storage device 310a. In a case where the last hole 30 in the processing order has already been provided, since there is no position data to be read, all the holes 30 are considered to have been provided. In this case, the laser processing processor 310 terminates the control flow. If there is position data to be read, it is considered that not all of the holes 30 have been provided, and the holes 30 that are not yet provided remain. In this case, the laser processing processor 310 advances the control flow to step SP13.

### (Step SP13)

This step is a moving step of moving the table 353 via the stage 351. In this step, the laser processing processor 310 moves the table 353 in the in-plane direction of the main surface via the stage 351 so that the position where the hole 30 of the position data read in step SP12 is to be provided is irradiated with the laser beam. That is, the laser processing processor 310 moves the table 353 as described above to a position where the hole 30 of the processing order subsequent to that of the hole 30 provided in step SP11 is to be provided. As the table 353 moves, the laser processing processor 310 returns the control flow to step SP11.

In the present example, as described above, when one hole 30 is provided, the irradiation of the workpiece 40 with the laser beam is stopped. Next, the irradiation position of the laser beam on the workpiece 40 is shifted by the movement of the table 353 in the in-plane direction. When the workpiece 40 is irradiated with the laser beam again after the table 353 is moved, another hole 30 is provided at the shifted irradiation position. When all the holes 30 are provided in the workpiece 40, the composite component 10 is completed.

The laser processing method is not particularly limited as long as all the holes 30 are provided in the workpiece 40. For example, all the holes 30 may be provided at substantially the same time by one-time irradiation with the laser beam. Alternatively, a part of the irradiation in step SP11 for a part of the holes 30 and a part of the irradiation in step SP11 for another part of the holes 30 may be alternately performed until respective holes 30 are provided.

### 2.4 Problem

In the composite component 10 of the comparative example, the direction of the arrangement of the holes 30 is not the same as the direction of the arrangement of the first fibers 21a and the second fibers 21b. In this case, most of the first fibers 21a and the second fibers 21b may be cut by the holes 30, and the strength of the composite component 10 may decrease.

Therefore, in the following embodiments, a composite component, a laser processing method, and a method for manufacturing a composite component, in which a decrease in strength can be suppressed, are exemplified.

### 3. Description of Composite Component, Laser Processing Method, and Method for Manufacturing Composite Component According to First Embodiment

### 3.1 Configuration of Composite Component of First Embodiment

The composite component of the first embodiment will be described. Any component similar to that described above is denoted by the same reference numeral, and duplicate description thereof is omitted unless otherwise specified. In the composite component of the present embodiment, the holes are described as through holes in the same manner as in the comparative example. Further, the depth direction of the holes which are through holes will be described as a direction perpendicular to the main surface of the workpiece, that is, along the thickness direction of the workpiece.

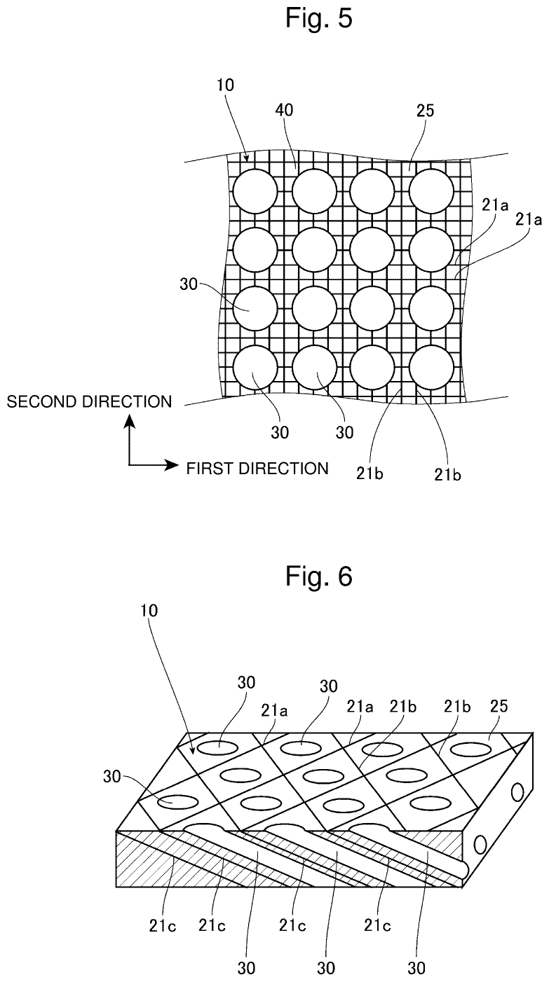

FIG. 5 is a front view of a composite component of the present embodiment. FIG. 5 illustrates a part of the front surface of the composite component 10. Further, in FIG. 5, for the sake of clarity, reference numerals are given only to a part of the same constitutive elements, and a part of the reference numerals are omitted.

In the composite component 10 of the present embodiment, the direction of the arrangement of the holes 30 with respect to the direction of the arrangement of the first fibers 21a and the second fibers 21b differs from that of the comparative example. Specifically, the direction of the arrangement of the holes 30 of the present embodiment is the same as the direction of the arrangement of the first fibers 21a and the second fibers 21b. That is, the first rows of the arrangement of the holes 30 of the present embodiment are along the first direction, and the second rows of the arrangement are along the second direction.

As in the comparative example, the center positions of the respective holes 30 of the present embodiment are arranged in a square grid, the plurality of first rows and the plurality of second rows are provided, and the plurality of holes 30 are provided in each of the first rows and each of the second rows. The holes 30 provided in the first rows also serve as the holes 30 provided in the second rows.

The distance between the centers of the holes 30 adjacent to each other in the first direction is the same as the distance between the centers of the holes 30 adjacent to each other in the second direction. The distance between the centers of the holes 30 adjacent to each other in the first direction is smaller than the distance between the centers of the holes 30 adjacent to each other in the direction oblique to the first direction. In addition, the distance between the centers of the holes 30 adjacent to each other in the first direction is the smallest among the distances between the centers of the holes 30 adjacent to each other among the plurality of holes 30.

In FIG. 5, an example is illustrated in which the number of holes 30 is constant in the respective first rows, the number of holes 30 is constant in the respective second rows, and the number of holes 30 in the respective first rows is the same as the number of holes 30 in the respective second rows. Note that the number of holes 30 may be different in the first rows, the number of holes 30 may be different in the second rows, or the number of holes 30 in any of the first rows may be larger or smaller than the number of holes 30 in any of the second rows.

The respective holes 30 are spaced apart from each other, and the region between the adjacent holes 30 is a region where the first fiber 21a, the second fiber 21b, and the matrix material 25 are provided. In each of the first rows, the first fiber 21a extending in the first direction between adjacent holes 30 in the first direction is a fiber cut by the adjacent holes 30. Further, in each of the second rows, the second fiber 21b extending in the second direction between the holes 30 adjacent to each other in the second direction is a fiber cut by the holes 30 adjacent to each other. In contrast, the first fiber 21a extending in the first direction between the adjacent first rows is a fiber that is not cut by the holes 30 in the first rows. Therefore, the holes 30 arranged in one of the adjacent first rows are provided on the opposite side of the holes 30 arranged in the other of the adjacent first rows with respect to the first fiber 21a extending in the first direction without being cut by the holes 30. Also, the second fiber 21b extending in the second direction between the adjacent second rows is a fiber that is not cut by the holes 30 in the second rows. Therefore, the holes 30 arranged in one of the adjacent second rows are provided on the opposite side of the holes 30 arranged in the other of the adjacent second rows with respect to the second fiber 21b extending in the second direction without being cut by the holes 30.

In the illustrated example, between the adjacent first rows, the number of the first fibers 21a extending in the first direction without being cut by the holes 30 is one, but may be two or more. In the illustrated example, the number of the first fibers 21a between the adjacent first rows is constant, but may be different. In addition, in the illustrated example, between the adjacent second rows, the number of the second fibers 21b extending in the second direction without being cut by the holes 30 is one, but may be two or more. Furthermore, in the illustrated example, the number of the second fibers 21b between the adjacent second rows is constant, but may be different. Moreover, in the illustrated example, the number of the first fibers 21a provided between the adjacent first rows is the same as the number of the second fibers 21b provided between the adjacent second rows. Note that the number of the first fibers 21a provided between the adjacent first rows may be more or less than the number of the second fibers 21b provided between the adjacent second rows.

Since the holes 30 are arranged in a square grid as in the comparative example, lines adjacent to each other among the lines passing through the centers of the holes 30 provided in the first rows along the first direction are arranged in parallel. Note that one of the adjacent lines may be arranged substantially parallel to the other of the adjacent lines as in the comparative example. Also, among the lines passing through the centers of the holes 30 provided in the second rows along the second direction, adjacent lines are arranged in parallel. Note that the one of the adjacent lines may be arranged substantially parallel to the other of the adjacent line as in the comparative example.

The composite component 10 of the present embodiment is used as a component of an engine in the fields of aeronautics, space, automobiles, power generation, and the like in which light weight, high strength, and heat resistance are required. Specifically, the composite component 10 is used, for example, as at least a part of at least one of a shroud, a combustion liner, a fuel nozzle, a swirler, a compressor blade, and a turbine blade. Each hole 30, which is a through hole, communicates with a pipe (not shown) on the rear surface of the composite component 10, and the pipe communicates with a cooling source (not shown). The cooling source pumps the cooling fluid through the pipe into the hole 30. The fluid flows from the holes 30 to the surface of the composite component 10 and cools the surface of the composite component 10.

### 3.2 Configuration of Laser Processing System for Manufacturing Composite Component of First Embodiment

A configuration of the laser processing system 50 of the present embodiment is the same as the configuration of the laser processing system 50 of the comparative example, and therefore a description thereof is omitted.

### 3.3 Operation

The method for manufacturing the composite component 10 of the present embodiment is the same as the method for manufacturing the composite component 10 of the comparative example. Further, the laser processing method of the present embodiment is the same as the laser processing method of the comparative example except that the arrangement of the holes 30 of the present embodiment is different from the arrangement of the holes 30 of the comparative example. In the laser processing method of the present embodiment, for example, the holes 30 are sequentially provided from the left side to the right side in the lowermost first row among the first rows when the composite component 10 is viewed from the front, by the movement of the stage 351. When the rightmost hole 30 is provided in the lowermost first row, the holes 30 are sequentially provided from the right side to the left side in the other first row one above the lowermost first row. Through the above-described repetition, the holes 30 are arranged, and the direction of the arrangement of the holes 30 is the same as the direction of the arrangement of the first fibers 21a and the second fibers 21b.

### 3.4 Function and Effect

The composite component 10 of the present embodiment includes the plurality of first fibers 21a extending in the first direction, the plurality of second fibers 21b extending in the second direction, and the matrix material 25 with which gaps between the first fibers 21a and the second fibers 21b are filled. Further, in the composite component 10, the plurality of holes 30 are provided in each of the first rows along the first direction and the second rows along the second direction.

According to the above configuration, in each of the first direction and the second direction, the direction of the arrangement of the holes 30 may be the same as the direction of the arrangement of the first fibers 21a and the second fibers 21b. When the arrangement directions are the same, the number of the first fibers 21a and the number of the second fibers 21b extending without being cut by the holes 30 can be increased as compared to the case where the arrangement directions are different, and a decrease in strength of the composite component 10 can be suppressed. Further, in the above configuration, the first fiber 21a extending in the first direction without being cut by the holes 30 is provided between the adjacent first rows. Further, in the above configuration, the second fiber 21b extending in the second direction without being cut by the holes 30 is provided between the adjacent second rows. Therefore, even if a plurality of the first rows and a plurality of the second rows are provided, the number of the first fibers 21a and the number of the second fibers 21b that are not cut by the holes 30 can be increased, and a decrease in strength of the composite component 10 can be suppressed. In the composite component 10 of the present embodiment, the holes 30 may be provided in each of at least one first row and at least one second row.

Further, the laser processing method of the present embodiment includes step SP11 which is an irradiation step in which the plurality of holes 30 are provided in at least one first row along the first direction and at least one second row along the second direction through irradiation of the workpiece 40 with the laser beam. The workpiece 40 includes the first fibers 21a extending in the first direction, the second fibers 21b extending in the second direction, and the matrix material 25 with which gaps between the first fibers 21a and the second fibers 21b are filled. Further, the method for manufacturing the composite component 10 of the present embodiment includes a processing step SP2 in which the workpiece 40 is laser-processed, and the plurality of holes 30 are provided in the workpiece 40 in each of at least one first row along the first direction and at least one second row along the second direction.

In the laser processing method and the method for manufacturing the composite component 10 according to the present embodiment, the direction of the arrangement of the holes 30 may be the same as the direction of the arrangement of the first fibers 21a and the second fibers 21b as described above, so that the composite component 10 in which the decrease in strength is suppressed can be obtained.

In the composite component 10 of the present embodiment, each of the holes 30 provided in the first rows also serves as one of the holes 30 provided in the second rows.

In the above-described configuration, the number of the holes 30 may be smaller than that in the case where each of the holes 30 provided in the first rows does not serve as one of the holes 30 provided in the second rows. When the number of the holes 30 is reduced, the number of the first fibers 21a and the number of the second fibers 21b cut by the holes 30 can be reduced, and a decrease in strength of the composite component 10 can be suppressed.

Further, in the composite component 10 of the present embodiment, the number of the first fibers 21a provided between the adjacent first rows is the same as the number of the second fibers 21b provided between the adjacent second rows.

In the above configuration, even if the composite component 10 is deflected by heat, an external force, or the like, the difference between the deflection amount of the composite component 10 with respect to the first direction and the deflection amount of the composite component 10 with respect to the second direction may be smaller than the case where the number of the first fibers 21a provided between the adjacent first rows is not the same as the number of the second fibers 21b provided between the adjacent second rows.

### 4. Method, and Method for Manufacturing Composite Component of Second Embodiment

### 4.1 Configuration of Composite Component of Second Embodiment

Next, the composite component of the second embodiment will be described. Any component same as that described above is denoted by the same reference numeral, and duplicate description thereof is omitted unless otherwise specified.

FIG. 6 is a perspective view of the composite component of the present embodiment. In FIG. 6, a part of a side surface of the composite component 10 is shown in cross-section. Further, in FIG. 6, for the sake of clarity, reference numerals are given only to a part of the same constitutive elements, and some reference numerals are omitted.

The composite component 10 of the present embodiment further includes a plurality of third fibers 21c that extend in a third direction that differs from the first direction and the second direction and is not perpendicular to the main surface of the composite component 10. The third direction is inclined with respect to the main surface of the composite component 10, that is, inclined with respect to the thickness direction of the composite component 10 perpendicular to the first direction and the second direction. The third fiber 21c has the same configuration as that of the first fiber 21a or the second fiber 21b. The adjacent third fibers 21c are arranged in parallel. Note that the adjacent third fibers 21c may be arranged substantially parallel to each other in the same manner as the first fibers 21a. The third fibers 21c are woven into the first fibers 21a and the second fibers 21b. The weaving includes three-dimensional weaving, wherein fiber bundles consisting of the first fibers 21a, the second fibers 21b, and the third fibers 21c are woven crosswise from the first direction, the second direction, and the third direction.

The holes 30 of the present embodiment are through holes in the same manner as the holes 30 of the first embodiment, but are different from the through holes of the first embodiment in that each of the holes 30 of the present embodiment is provided along the third direction. Therefore, the depth direction of each of the holes 30 of the present embodiment is along the third direction. The depth direction is a direction along which the central axis passing through the center of gravity of the hole 30 extends, and is a penetrating direction of the composite component 10.

Since the depth direction of the hole 30 is along the third direction as described above, the third fiber 21c extending in the third direction between the adjacent holes 30 is a fiber that is not cut by the holes 30. In the illustrated example, between the adjacent holes 30, the number of the third fibers 21c extending in the third direction without being cut by the holes 30 is one, but may be two or more. In the illustrated example, the number of the third fibers 21c between the adjacent holes 30 is constant, but may be different. In addition, in the illustrated example, the number of third fibers 21c provided between the adjacent holes 30 is the same as the number of the first fibers 21a provided between the adjacent first rows. In addition, in the illustrated example, the number of the third fibers 21c is the same as the number of the second fibers 21b provided between the adjacent second rows. The number of the third fibers 21c may be more or less than the number of the first fibers 21a provided between the adjacent first rows and the number of the second fibers 21b provided between the adjacent second rows.

### 4.2 Configuration of Laser Processing System for Manufacturing Composite Component of Second Embodiment

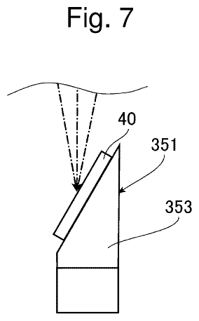

The configuration of the laser processing system 50 is the same as the configuration of the laser processing system 50 of the comparative example except for the configuration of the table 353. FIG. 7 is a side view of a table according to the present embodiment. As shown in FIG. 7, the table 353 is inclined so that the in-plane direction of the table 353 is inclined with respect to the optical axis of the laser beam traveling to the table 353. In this case, the table 353 supports the workpiece 40 such that the thickness direction of the workpiece 40 is oblique to the optical axis of the laser beam incident on the workpiece 40, and the third direction is along the optical axis. When the workpiece 40 is supported by the table 353 as described above and the workpiece 40 is irradiated with the laser beam, the holes 30 extending in the third direction are provided.

### 4.3 Operation

The method for manufacturing the composite component 10 according to the present embodiment is the same as the method for manufacturing the composite component 10 according to the first embodiment, and thus the description thereof will be omitted. Further, since the laser processing method of the present embodiment is the same as the laser processing method of the first embodiment, the description thereof will be omitted. Since the workpiece 40 is supported by the table 353 as described above, in step SP11 which is the irradiation step, the laser beam irradiates the workpiece 40 along the third direction.

### 4.4 Function and Effect

In the above configuration, the number of the third fibers 21c cut in the thickness direction of the composite component 10 can be reduced as compared with the case where the depth direction of each hole 30 is along the thickness direction of the composite component 10, and the decrease in strength of the composite component 10 can be further suppressed. The third direction may be along the thickness direction of the composite component 10, and the depth direction of the third fibers 21c and the holes 30 may be along the thickness direction of the composite component 10. In this case, the main surface of the table 353 is substantially orthogonal to the optical axis of the laser beam with which the workpiece 40 is irradiated as in the first embodiment.

Although the above embodiment has been described as an example, the present disclosure is not limited thereto, and can be modified as appropriate.

The composite component 10 is not limited to a plate shape. The composite component 10 is not required to be a CMC as long as it is provided with the first fibers 21a, the second fibers 21b, and the matrix material 25. A plurality of fiber bundles composed of the plurality of first fibers 21a and the plurality of second fibers 21b may be provided, and the respective fiber bundles may be laminated to each other in the thickness direction of the composite component 10. The weaving of the first fibers 21a and the second fibers 21b is not required to be limited to plain weaving, but may be twill weaving or satin weaving. The first fibers 21a may be woven into the second fibers 21b and may not intersect the second fibers 21b in an alternate manner to be woven into the second fibers 21b. The first direction may not be orthogonal to the second direction as long as it intersects the second direction.

The first fibers 21a and the second fibers 21b and the center positions of the respective holes 30 may be arranged in a grid in a shape of, for example, triangle, rectangular, parallelogram, or other polygons in addition to a square grid. In addition, at least one hole 30 provided in at least one first row does not have to serve as one of the holes 30 provided in the second row. The holes 30 may not be through holes.

The distance between the centers of the adjacent holes 30 in the first direction is not necessarily the same as the distance between the centers of the adjacent holes 30 in the second direction, and may be smaller or larger than the distance.

Instead of moving the table 353, the traveling direction of the light from the laser processing apparatus 300 to the workpiece 40 may be shifted in the in-plane direction by a galvanometer scanner or the like, and the irradiation position on the workpiece 40, that is, the irradiation spot of the laser beam on the workpiece 40 may be shifted in the in-plane direction. Alternatively, the traveling direction of the light from the laser processing apparatus 300 to the workpiece 40 may be shifted as the table 353 moves. The table 353 may be rotated so that the in-plane direction of the table 353 is perpendicular or oblique to the optical axis of the laser beam traveling to the table 353 in accordance with the direction in which the third fibers 21c in the workpiece 40 supported by the table 353 extends. The laser beam is preferably a pulsed laser beam from the viewpoint that the peak value of the laser beam with which the workpiece 40 is irradiated is increased and the workpiece 40 is efficiently formed, but may be a continuous beam.

The description above is intended to be illustrative and the present disclosure is not limited thereto. Thus, it would be obvious to those skilled in the art that changes may be made to the embodiments of the present disclosure without departing from the scope of the claims set out below. Further, it would be also obvious to those skilled in the art that embodiments of the present disclosure would be appropriately combined.

Terms used throughout the specification and the claims should be interpreted as “non-limiting” terms unless expressly stated otherwise. For example, terms such as “comprise”, “include”, and “contain” should not be interpreted to be exclusive of other structural elements. For example, terms such as “have”, and “having” should not be interpreted to be exclusive of other structural elements. Further, indefinite articles “a/an” should be interpreted to mean “at least one” or “one or more.” Further, “at least one of A, B, and C” should be interpreted to mean any of “A”, “B”, “C”, “A+B”, “A+C”, “B+C”, and “A+B+C.” In addition, combinations thereof with other matters than “A”, “B”, and “C” should also be construed as being encompassed.

What is claimed is:

1. A composite component comprising:
a plurality of first fibers extending in a first direction;
a plurality of second fibers extending in a second direction different from the first direction; and
a matrix material with which gaps between the first fibers and the second fibers are filled,
a plurality of holes being provided in each of at least one first row along the first direction and at least one second row along the second direction.

2. The composite component according to claim 1, wherein at least one hole of the holes provided in the at least one first row also serves as one of the holes provided in the at least one second row.

3. The composite component according to claim 1, wherein a number of the first fibers provided between adjacent first rows of the at least one first row is same as a number of the second fibers provided between adjacent second rows of the at least one second row.

4. The composite component according to claim 1, wherein the first direction and the second direction are orthogonal to each other.

5. The composite component according to claim 4, wherein the holes are arranged in a square grid.

6. The composite component according to claim 1, further comprising
a plurality of third fibers extending in a third direction different from the first direction and the second direction, wherein
a depth direction of each of the holes is along the third direction.

7. The composite component according to claim 6, wherein the third direction is inclined with respect to a thickness direction of the composite component.

8. The composite component according to claim 1, wherein the holes are through holes.

9. The composite component according to claim 1, comprising a ceramic matrix composite.

10. The composite component according to claim 1, wherein the composite component is at least a part of at least one of a shroud, a combustion liner, a fuel nozzle, a swirler, a compressor blade, a turbine blade, and a turbine vane.

11. A laser processing method comprising
irradiating a workpiece with a laser beam, the workpiece including a plurality of first fibers extending in a first direction, a plurality of second fibers extending in a second direction different from the first direction, and a matrix material with which gaps between the first fibers and the second fibers are filled, to provide a plurality of holes in each of at least one first row along the first direction and at least one second row along the second direction.

12. The laser processing method according to claim 11, wherein
the workpiece further comprises a plurality of third fibers extending in a third direction different from the first direction and the second direction, and
a depth direction of each of the holes is along the third direction.

13. The laser processing method according to claim 12, wherein the third direction is inclined with respect to a thickness direction of the workpiece.

14. A method for manufacturing a composite component by laser-processing on a workpiece, the workpiece comprising a plurality of first fibers extending in a first direction, a plurality of second fibers extending in a second direction different from the first direction, and a matrix material with which gaps between the first fibers and the second fibers are filled, the method comprising
laser processing the workpiece to provide a plurality of holes in each of at least one first row along the first direction and at least one second row along the second direction.

15. The method for manufacturing a composite component according to claim 14, wherein
the workpiece further comprises a plurality of third fibers extending in a third direction different from the first direction and the second direction, and
a depth direction of each of the holes is along the third direction.

16. The method for manufacturing a composite component according to claim 15, wherein the third direction is inclined with respect to a thickness direction of the workpiece.
